(19) United States
(12) Patent Application Publication
(10) Pub. No.: US 2016/0307285 A1
(43) Pub. Date: Oct. 20, 2016

(54) SYSTEM AND METHOD FOR PREDICTIVE MODELING OF GEOSPATIAL AND TEMPORAL TRANSIENTS THROUGH MULTI-SOURCED MOBILE DATA CAPTURE

(71) Applicant: Peter E Gallagher, Chatham, NJ (US)

(72) Inventor: Peter E Gallagher, Chatham, NJ (US)

(21) Appl. No.: 14/686,286

(22) Filed: Apr. 14, 2015

(51) Int. Cl. G06Q 50/26; G06F 17/30

(52) U.S. Cl. CPC G06Q 50/265; G06F 17/30241

(57) ABSTRACT

A system and method for predicting an event comprising a plurality of users having a user account comprising an identifier, and a log of current locations and historical geospatial/temporal data points of the plurality of users when using the system. The system and method are configured to receive information of a plurality of events from the plurality of users. The information of the plurality of events comprise a photograph; a sound recording; a geo-location marker; a custom message or descriptor; a digital time stamp; and/or, other location- and time-specific classifications. The system and method store the information of the plurality of events to a plurality of databases; record and perform longitudinal, geo-dependent analytics of the plurality of events; and from the information of the plurality of events predict an event of similar nature in geospatial and temporal dimensions.

### CLAIM OF PRIORITY

This application claims no priority to any previous United States patent application.

### FIELD OF THE EMBODIMENTS

This invention relates to a system and method for predictive modeling of geospatial and temporal transients through the capture and analysis of geo- and time-dependent events. In particular the invention relates to a method of preventing distracted driving (e.g., use of cell phones, texting behind the wheel, etc.) by providing a means to report and predict location-specific, longitudinal occurrences of distracted driving.

### BACKGROUND OF THE EMBODIMENTS

Distracted driving ranks as one of the most commonly accepted and observed public hazards in today's technology-connected society. According to the Centers for Disease Control and Prevention, in each of the last few years more than 3,000 people have died and more than 400,000 were injured in the United States alone because of distracted driving. At the same time, while 98% of Americans know that texting while driving is dangerous, 49% of daily commuters do it. Texting while driving and other forms of distracted driving have become so prevalent that the U.S. Department of Transportation has labeled distracted driving a “persistent and growing epidemic.” Numerous advertising and awareness campaigns have been launched—especially focused on new teen drivers—to encourage people to stop engaging in distracted driving, but these campaigns have had limited success in creating sustainable behavioral change.

Accordingly, alternative means for reporting, predicting and, ultimately, discouraging distracted driving should be developed. In creating these alternative means, one must consider how to spot, report and analyze the location and time of distracted driving. Further, it would be beneficial to document the form of distracted driving (e.g. texting, handheld phone, eating, etc.) so that more customized prevention techniques can be both developed and rapidly implemented. These data could be used by law enforcement, insurance carriers, community watch programs, parents and others to most appropriately address and reduce each type of distracted driving.

Examples of related art are described below:

U.S. Pat. No. 8,775,816 discloses a method of recording real-time data (video data, photographs, audio data and text data), on a mobile device regarding an area of interest or events occurring in the area of interest, providing a time-stamp for the recorded data, providing geo-location information for the recorded data, selectively annotating the recorded data with additional information, and, uploading the recorded data to a central network location.

U.S. Pat. No. 8,744,230 teaches a real-time streaming geo-location method which includes recording data and linking it to specific coordinates, storing and filtering data, and ultimately streaming video from the stored data.

U.S. Pat. No. 8,466,310 discloses a system accessing, by a computing system, situational data, wherein the situational data includes information of a physical condition at a location proximate to the one or more monitor systems, wherein the physical condition at the location proximate to the one or more monitor systems is selected from the group consisting of a variety of characteristic of a particular location.

U.S. Patent Publication No. 2007/0117573 teaches a method for generating geocoded data for a wireless communication system works over a plurality of network architectures and location processes. The method identifies the presence of mobile activity in the wireless communication network and in response collects wireless communication measurement data associated with the mobile activity.

U.S. Publication No. 2013/0039542 discloses a method of reviewing, sharing and viewing geo-location specific multimedia files from a mobile phone in real-time by police in a remote network operations center (“NOC”).

None of the art described above addresses all of the issues that the present invention does.

There is an existing need for a system to prevent distracted driving through the collection and analysis of real-time, location-specific data, as reinforced through the inventor's conversations with students, parents, law enforcement and various community and business organizations. The current methods to prevent distracted driving, including public service announcements, pledges and cell phone/smartphone blockers, have proven incapable of influencing significant behavioral change across the spectrum of drivers, from daily commuters to new teen drivers. Meantime, observational studies of when and where distracted driving is occurring have been limited, time-consuming and very expensive. This lack of comprehensive data has prevented the execution of a robust analysis from being conducted on when and where distracted driving occurs, or will most likely occur next. A system that attempted to achieve this data collection and subsequent modeling would benefit from the use of a multitude of users contributing to the documenting and categorization of the instances of observed distracted driving. Today's prevalence of geo-tracked smartphones and mobile apps enables this system of multi-sourced data capture to deliver and process heretofore unavailable scale and scope of geographic and temporal data that is required to stop the epidemic of distracted driving.

Other applications can collect data from users and enable the users to perform their own predictive modeling (i.e., make the data available, but not perform the actual modeling for the user).

The unique combination in this application is that users are enabled and incentivized to report time/location/environmental data on their mobile devices, and then the software automatically analyzes the ever-growing database to produce forward-looking statistical outcomes.

The described system and method will generate two forms of actionable, currently non-existent data: i) a real-time mapping of occurrences per location and time, and ii) predictive modeling of where and when similar events will occur in the future. Users of either form of data can then employ technical and non-technical actions to identify and penalize distracted drivers, as well as implement preventative measures to avoid the next event of distracted driving from occurring.

### SUMMARY OF THE EMBODIMENTS

A system for predicting an event; comprising: a memory that stores computer-readable instructions; a processor, communicatively coupled to the memory that facilitates execution of the computer executable instructions, and comprising: a plurality of users, wherein the plurality of users have a user account comprising: an identifier, personal information provided by said plurality of users, a log of the locations of the plurality of users when using the system, a server configured to: receive information of a plurality of events from the plurality of users; comprising at least one of the following: a photograph; a sound recording; a location stamp; a custom text or descriptor; a time stamp; a source identifier; and/or a customizable classification; store said information of the plurality of events to a plurality of databases; record the information of the plurality of events; and predict an event of similar nature from the information of the plurality of events.

In general, the present invention employs an application on a user's mobile device to enable the user to record a specific event that has been observed. A user records an event by taking a picture of the event or selecting textual or graphical descriptors of the event. Along with this photo or descriptor, a user's location is logged by accessing the GPS platform operating in the mobile device. Once the event has been recorded via the application, the user's mobile device will send the information to a server where the record of the event, including corresponding location, time, data, and descriptor data are stored. Once on the server, the record of the event is characterized based on the information provided by the user. This characterization will be used by the system to evaluate and classify the nature of the recorded event in the context of historically-similar and -dissimilar events. One output of this data analysis will be the statistical modeling of the probability than an event with a similar characterization will occur. One such use of this anticipatory analysis would be to predict the likelihood and form of distracted driving occurring at a specific location, time and day.

The present invention provides benefits to numerous industries. Any event that occurs in the presence of a large number of people, or by the same person at different times or locations, is suited to benefit from this invention. In other words, if users are able to log information about discrete geospatial and temporal observations on a common platform, then predictive analytics and statistical modeling could be employed to inform, assess, manage, and/or drive decision-making and the allocation of resources that would influenced by the system output.

It is an object of the present invention to provide a means for users to record geo-specific, time-stamped events, including natural- and human-instigated environmental conditions and dynamics.

It is an object of the present invention to allow a plurality of users to log similar information such that it may be stored.

It is an object of the present invention to allow for longitudinal studies and predictive analytics to be performed on the events recorded by the users.

It is an object of the present invention to provide a means to improve health, security and safety.

It is an object of the present invention to provide a means to prevent loss and improve performance, yield and output.

It is an object of the present invention to provide a means to improve decision-making and optimize resource allocation.

### BRIEF DESCRIPTION OF THE DRAWINGS

FIG. 1 shows a graphical illustration of the system's user interface screens.

FIG. 2 shows another graphical illustration of an alternative user for an embodiment of the present invention.

FIG. 3 shows an overview of how data is processed within an embodiment of the system of the invention.

FIG. 4 shows a graphical illustration of a generalized description of how predictive modeling works.

FIG. 5 shows an example of the data output of an embodiment of the present invention.

FIG. 6 shows the embodiment of the gamification protocol of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

### User Interface

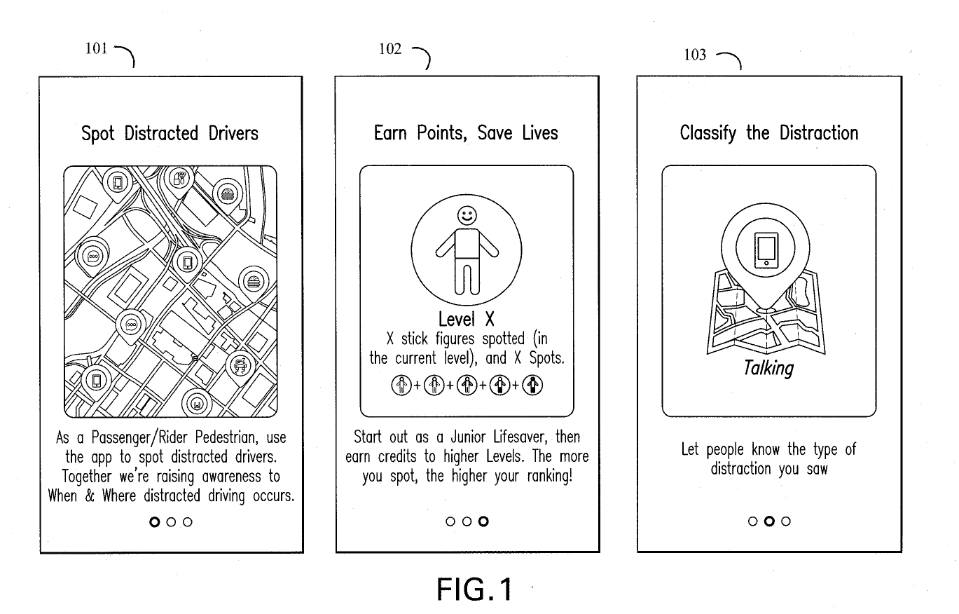

Referring to FIG. 1, in a preferred embodiment of the present invention, a new user of the system will be given an overview of how the system operates. First informational screen 101 informs a user of the system's mission to help spot and eliminate distracted driving. Second informational screen 102 shows how the gamification of the system operates. Third informational screen 103 highlights some of the additional functions of the system. When a new user first operates the system, this user will be able to readily transition between viewing first informational screen 101, second informational screen 102, and third informational screen 103.

In a preferred embodiment, a user may register to use the system through direct registration or through the user's social media account, such as Facebook or Twitter. The user is then prompted to permit the application to receive real-time location data from the user's existing global positioning system (GPS), contained within the mobile device (note: if the user does not permit this transfer of location-based data to the application, the application may not function on the user's mobile device). Upon logging in to the mobile application, a user is prompted with a question to confirm whether they are the Driver of a vehicle or a Passenger/Rider in a vehicle. If the user selects that he/she is a Driver, then the user is prevented from proceeding with the application, as the application is meant to prevent drivers from using their mobile phones while behind the wheel of a vehicle. In another embodiment, the application will not permit the same user to report an occurrence of distracted driving repeatedly (perhaps, erroneously or with false pretense) at the same location within a short, predetermined amount of time.

If the user selects Passenger/Rider, the user is allowed to use the application. Thereafter, a map or other similar graphical representation is presented to the user. The global positioning system (GPS) operating within the mobile device or similar device of the user initiates integration into the system. A user is then assigned an Avatar or similar graphical representation of the user. In another embodiment, a photo of the user may be used or the Avatar may be changed or amended depending on the event or condition being captured, the historical performance of the user, and/or the location and/or time of day that the user is employing the system. At this point, the user may use the system to report his/her observance of a distracted driver or similar event or condition.

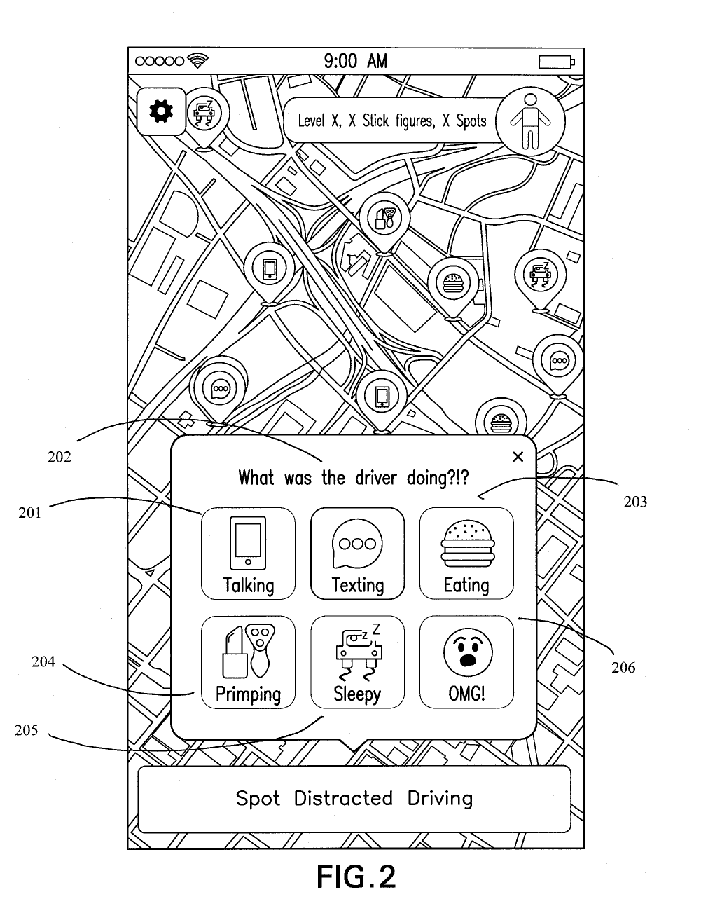

Referring to FIG. 2, the user of the system may use their mobile device to capture an image, photograph, sound recording, video and/or descriptor of a distracted driver. A distracted driver is defined as a driver whose judgment or awareness is diminished due to cognitive, manual or visual distractions. As shown in FIG. 2, a user is prompted to classify the type of distracted driving via button for reporting talking on a phone without a headset 201, button for reporting texting while driving 202, button for reporting eating or drinking without proper focus on the road 203, button for reporting primping or shaving while driving 204, button for reporting loss of focus due to drowsiness or sleep 205, or button for reporting any other action that reduces or limits the driver's ability to safely and effectively operate behind the wheel 206. In another embodiment, a distracted driver may be classified as texting while driving; talking on a phone without a headset; eating or drinking; primping or shaving; drowsy; or otherwise cognitively, visually or manually distracted from their responsibilities behind the wheel. In yet another embodiment, the image, photograph and/or sound recording may be taken of an event or condition such as a black ice observed by a pedestrian on a sidewalk or the reporting of a burned-out street light that results in an unnecessarily dangerous environment in a parking lot after dark. A multitude of events can be captured and such images can be captured or recorded using a plurality of image capturing devices. Once an event is “spotted” and captured by an individual, the user has the opportunity to share the event occurrence (event description, time, date, etc.) via social media using the pre-programmed template or a customized message. In an alternative embodiments, a user may log other things such as videos, smells, among many other things.

The information that is communicated to the other users of the system is used to inform other individuals that a distracted driver has been observed at a particular location and time. Users may find this information to be very valuable as a means to identify and track which roads and intersections have the highest observed prevalence of distracted driving, and at what times. Users will be empowered to avoid those locations and reduce their own risk of future accident caused by a distracted driver. The system incentivizes an individual to capture such events. For example, the system awards a person points and recognition for spotting a distracted driver. In the present example, an individual who forewarns another person of high prevalence of distracted driving in a certain location could potentially save another's life or help them to avoid an accident caused by distracted drivers in that area. In addition, the system acts as a deterrent for the distracted driver by raising awareness. The location of the distracted driver is recorded by a point on a map or similar graphical representation. While planning their route, other drivers (before getting behind the wheel) can use the system to see where distracted driving has occurred in their neighborhood or on their commute, and therefore map a route to avoid that more dangerous street.

In a preferred embodiment, this collected data is stored and recorded by the system and used by a prediction engine within the system to forecast to users where distracted driving is being observed, what time of day and day of the week events are most often occurring (being observed), and what types of distractions are more prevalent at a particular location or time. Once an event or condition is captured, the user who captured the image may share the image in social media or comment on the image before sharing the image with others.

In another embodiment, the plurality of events or conditions that are captured or recorded can be used by the system's prediction engine to forecast patterns of behavior, performance or other human-driven environmental dynamics, such as which consumer products are consumed when, in what location and by whom (i.e., a “geographic consumption” model).

### Data Processing and Storage

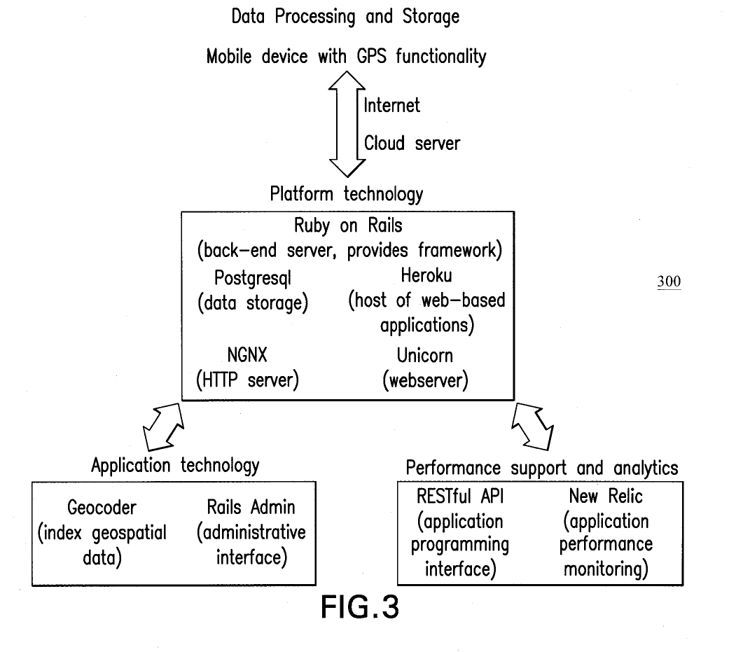

Referring to FIG. 3, an overview of how data is handled within an embodiment of the system of the invention is provided for. This preferred embodiment is delineated by system 300. Images, events or conditions are captured via a mobile device and are processed through software to be stored in a database. Key elements of the data processing and storage operations are as follows:

### Client Overview and Technology Stack:

The client application runs on a mobile device, and was built with a combination of proprietary and open source software. Authentication is achieved through Facebook Omniauth and Twitter Omniauth, and is easily extendable to other OmniAuth providers as required.

The primary utilized mapping software is Leaflet.js, Mapbox.js along with several small Leaflet.js plugins. More specifically, Leaflet.js provides a mobile-first alternative to Google Maps, and offers a suite of tools for building map-based applications. It is highly customizable and can easily be ported to a browser application. Mapbox.js provides the actual map graphics, and is highly customizable in terms of look and feel.

Client geo-location is achieved through the mobile device's built-in GPS technology and requires an internet connection to function. The application thus also relies upon an internet connection to operate, although future iterations could forgo an internet requirement by caching map data along with nearby crowdsourced data and allowing users to navigate themselves on the map in lieu of GPS technology.

### Back-End Overview and Technology Stack:

The back-end software is built under the umbrella of Ruby on Rails. Ruby on Rails is a framework rather than one piece of technology. Its purpose is to facilitate the development of web applications by making the integration of disparate web technologies as seamless as possible, so that the client, server, and database can all be developed and deployed in conjunction in a simple, efficient and clean manner.

The back-end technology stack consists of platform software and application software. An overview of the main components follows:

### Platform Technology:

Heroku: Heroku is a cloud platform for hosting web-based applications that provides highly scalable architecture and simple third party software integration with various cloud service providers.
Postgresql: Postgresql provides relational database software, and is used for storing all application-related data.
NGNX: This is a high-performance HTTP (Hypertext Transfer Protocol) server.
Unicorn: Ruby-based webserver that acts as a glue between NGNX and Ruby on Rails (or other Rack-based web applications).

### Application Technology:

Geocoder: As its name suggests, Geocoder provides a suite of geocoding-based tools for Ruby on Rails applications. The invention leverages Geocoder for a variety of functions, most importantly its ability to index geospatial data and efficiently perform radius-based lookups in the database.
Rails Admin: Rails Admin provides a unified administrative interface to all data stored in the application's database. This software provides a highly-customizable and efficient window for viewing, updating and deleting user data.

### Back-End Functionality:

In terms of the application's usability and performance, the two most important back-end functions are the application's RESTful API and geospatial data storage/retrieval.

The API provides four main functions to authenticated users who have signed into the application:
Permits the mobile client to send GPS coordinates to the server and retrieve all geotagged data from the database within the coordinates' nearby radius.
Permits the mobile client to send ‘spots’ to the server to be stored in the database.
Permits the mobile client to classify ‘spots’ according to pre-determined categories.
Stores and retrieves user settings, usage history and score.

As mentioned in the application technology overview, the invention relies on Geocoder to provide an interface for retrieval of geospatial data from a relational database. In the application's case, as users move about the map, user coordinates are continuously sent to the server so that nearby spotting data can be retrieved and sent to the user. The application's design mandates that these lookups occur as instantaneously as possible. Due to the thousands—and potentially millions—of rows of data stored in and coordinated across the database, an efficient and scalable mechanism is required. Geocoder achieves this solution through sophisticated indexing of data that allows near instantaneous retrieval of information, including at large-scale.

### Analytics and Metrics

Performance monitoring is achieved through New Relic, which allows site administrators to monitor and profile back-end performance in an extremely granular manner. All errors are logged and stored for later analysis.

### Data Ownership

Though all data is stored in the cloud, it is ostensibly owned by the application owner. The database is backed up on a regular basis, several times per day, and can be auto-exported to an external platform to provide protection against Heroku outages.

### Data Processing and Mining

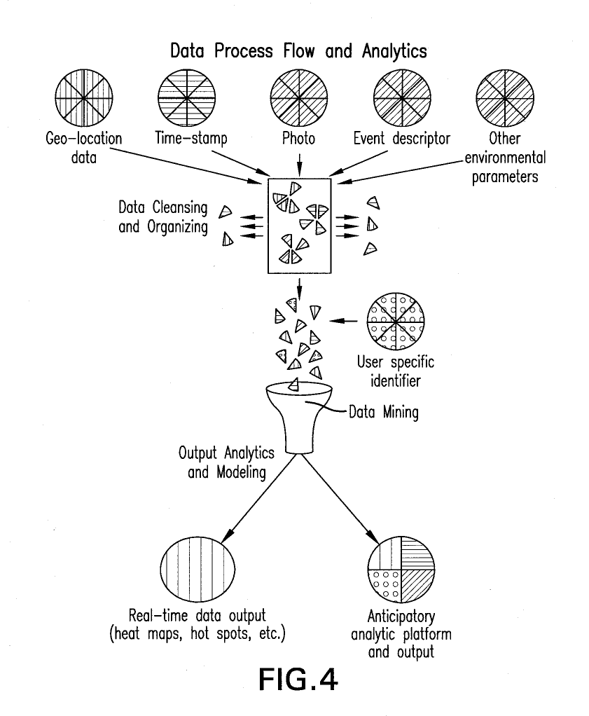

Data collected by the application are processed through a flow as shown in FIG. 4. Specific data elements captured by the user are cleansed and organized upon reporting of a distracted driving event. The datapoint is checked for validity (cleansed) via a comparison against a series of parameters that are used to confirm the degree of veracity and probability that the user reported what was actually observed (for example, if an unusual event is reported multiple times within a short period of time, the filter will disregard the “dirty” datapoint, and inform the user of the decision). Clean data is then organized in a manner that enables data mining and the exploration of patterns or systematic relationships to be performed across the various dimensions and variables that are captured and reported by the multitude of users. The output is delivered in two forms: real-time updates to the application being used by the user (i.e. updates provided to the screen of the mobile device), and forward-looking analytics that model the probability and likelihood of future data patterns and inter-dependence of variables based on historical data capture.

In another preferred embodiment, the system will contemplate historical data of the occurrences at a given location, as well as information derived from a multitude of users to strengthen the modeling. This is achieved by the inclusion of more data in the analysis, leading to stronger predictions.

### Output: Real-Time Data

Redefining the scale, scope and impact of traditional observational studies, the system provides various tools to visually evaluate and statistically analyze the current and historical collection of data points that have been reported by the multitude of users. Cluster heat maps, hot spots, and, more simply, “dropped pins on a digital map” are examples of the fully customizable graphical displays available to the user to observe reported data points. The user has the option to observe only his/her data points or to include the historical universe of all users' data points. Users can also set parameters to observe all historical data, or customize the display to include a more limited data set, for example, over a selected period of time on a particular day, or set of days. The graphical representations of data can be modified to show only the variables that are most relevant to the user. For example, if this user only wants to analyze a heat map of distracted drivers who had been observed texting-while-driving on Monday mornings from 9:00 am to 11:00 am in a particular city of New Jersey.

The data is also available to the user in tabular form, such as a spreadsheet, so that a range of statistical analyses can be performed on the observed universe of data and variables. For example, a municipality could perform an analysis to determine which locations and times of day within their district have the highest prevalence of observed distracted driving. Based on this output, the municipality could better align resources and preventive actions to reduce and discourage dangerous driving behaviors (for example, increase law enforcement presence or install public safety signs and messages to alert pedestrians to increased danger in crosswalks or street corners at the identified locations and peak times of observed distracted driving).

### Output: Predictive Modeling

Predictive analytics is an area of data mining in which information is extracted from data, and an algorithm is run on that information, yielding some predictions about what happens. For example, one might take recent census data and extract all of the female baby names. If one were to take that data and perform predictive analytics on it, with the proper algorithm, one could arrive at what the most common baby name would be in the following year.

There are many different types of predictive analytics. One such type is geospatial predictive modeling. Put simply, geospatial predictive modeling examines information about certain events, including the location of these events, to attempt to establish patterns between the occurrences and the locations in which they occur. This data can be used, for example, to determine if certain intersections are more dangerous than others. Another example of this is to determine high-crime areas and predict where crime will occur based on those determinations.

The applications of geospatial and temporal predictive modeling driven by a plurality of mobile devices are increasingly broad and the impact of such analytics presents significant opportunities to improve safety, security, health, as well as deliver operational improvements and more optimized resource allocations. If provided with the appropriate and sufficient data, geospatial and temporal predictive modeling will have beneficial effects in a range of industries and applications, including law enforcement, government intelligence, futures trading, optimization of internet traffic, public health and the control of infectious diseases, as well as applications for logistics, geographically distributed sales forces (e.g. pharmaceutical sales representatives) and supply chain initiatives.

In a preferred embodiment, the present invention employs predictive modeling of geospatial and temporal dynamics that are captured and reported via multiple mobile devices. For example, users could submit electronic reports that contain a photograph, a sound recording, a digital location stamp, a customized text or event descriptor, a digital time stamp, and/or a classification of what was observed. The present invention would take a plurality of these reports and determine trends that exist between the various reports. These trends are then extrapolated through a statistical modeling program to make reliable predictions about where and when instances of distracted driver are most likely to occur.

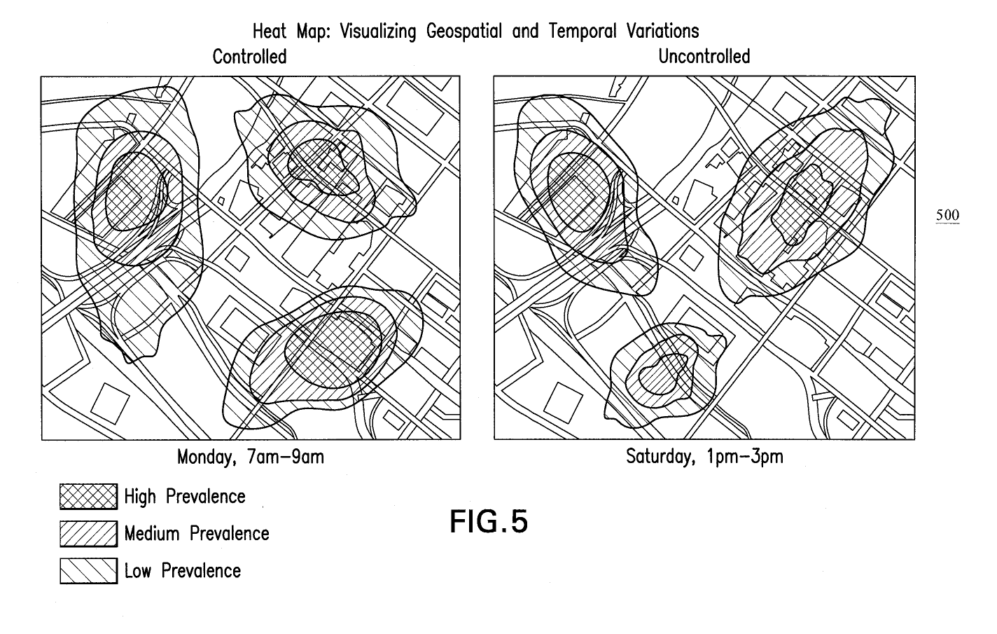

As shown in FIG. 5, for example, the predictive modeling capability of the system provides for a graphical display of “hotspots” of distracted driving 500. An innovative tool for a user to see future geospatial and temporal variations of a particular reported event, such as distracted driving. Even more powerful, the analytical tools enable the user to modify the variables being considered (i.e. the Controlled model, subject to user-selected variables for analysis, the Uncontrolled model, which displays the forecast based on all available data, including that provided from external or other historical (analog or digital) sources) so that a user could see what impact his/her historical performance will have (or not have had) on the future probability of similar events. The system could also deliver forward-looking data to the user regarding what events, within a geospatial and time-dependent context, would be most relevant to his/her particular interests, hobbies or profile.

### User Experience

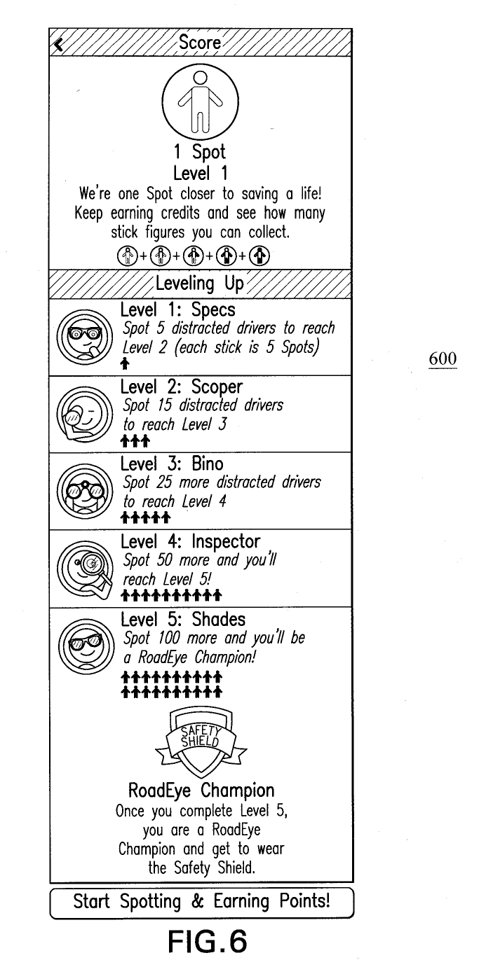

In the present system, there are varying degrees of levels associated with the amount of captured images, events or conditions that a user reports or shares with the community of other users, as shown in FIG. 6. FIG. 6 depicts scorecard 600. Scorecard 600 shows that users are incentivized through virtual rankings, titles and other forms of online, social gamification to actively participate in the community. For example, the levels span from Level 1 to Level 5 and vary with the number of images, events and conditions a user shares. For example, Level 1, entitled Specs, is assigned when a user registers to use the system. The user continues in this level until he/she report the observation of four distracted drivers. Once a user reports these four distracted drivers, he/she are promoted to Level 2, entitled Scoper. At fifteen distracted driving events, a user moves to Level 3, entitled Bino, where they remain until they spot another twenty-five distracted drivers. The user then progresses to Level 4, receiving the title Inspector, where he/she remains until another fifty distracted drivers are reported. When the user observes and reports an additional one hundred distracted drivers, he/she reaches Level 5, entitled Shades, and is recognized as a Champion of the system. Level 5 users are informed that they have earned a virtual Safety Shield due to their achievements.

In another embodiment of the invention, the Levels and classifications can be renamed to match the event or condition a user is tasked with capturing, recording and sharing with the community of other users. Each level corresponds to points and points may correspond to rewards and prizes appropriate for the event and condition captured and shared with the community of other users.

It should be noted that in one embodiment of the present invention, the predictive results, as well as the information contained in the databases will be provided to the users in real-time. Further, the technology employed by the present invention provides a broad range of industries with customizable, individual-user level observational studies that can be planned and executed in real-time at very low cost.

The software and mobile device application of the present invention will enable geo/time/environmental data collection on an unprecedented scale that will drive decision-making for today's problems, and also predictively model and inform where the next problem, bottleneck or market opportunity will take shape.

### System Applications Beyond Distracted Driving

The many elements of the present invention make it unique and innovative in the field of mobile data collection and analytics. Additional uses for the invention can be found in public health (e.g. real-time reporting and geo-tracking of outbreaks of infectious disease, or the geospatial/temporal monitoring and predictive awareness of contagions of such as lice or chicken pox within a school or school district), agriculture (e.g. geospatial variation in the performance of crops as a function of time-based interventions), and across various hobbies and professions (e.g. bird clubs tracking seasonal migrations, performance of field-based sales representatives, emergency response teams during/post-casualties).

The present invention can be used for safety and security. For example, colleges, universities, shopping malls, concert venues and other large gathering spots can use the present invention to identify safety/security lapses identified by customers, as well as predictive modeling to avoid future lapses. Further the present invention can have military as well as Department of Defense applications. The present invention also contemplates public/private partnerships for satellite-driven data collection, and partnerships with the gas and oil industry to enable broader tracking of their geographically-dispersed assets (pipelines, power lines).

In an alternative embodiment, the present invention may be employed by utility companies, who could empower their customers to report time/location/environmental conditions before, during or after a natural (or other) disaster in order to expedite recovery time and most efficient allocation of resources after an emergency. Further, school nurses, hospitals, Centers for Disease Control, etc. may leverage the present invention for communities to report individual cases of infectious illnesses and diseases (ebola, chicken pox, lilce, etc), enabling real-time projections of communities next at risk.

It should be noted that in a preferred embodiment of the present invention, a user will be notified of an occurrence of an incident when they are in close proximity to said incident. In another embodiment, notifications increase in severity with each repeated event.

Moreover, the present invention is capable of supporting new drug clinical trials, so investigators can add location/time/environmental factors to the study of drug effectiveness in different populations and engage in analysis of sales representative effectiveness, by evaluating geo/time dimensions of their sales calls in generating leads and closing deals (applicable to any geo-varying sales force). Additionally, the present invention will provide a more detailed reporting of logistics and conditions, by enabling more users and observers to report on and be informed of time/location/environmental factors to logistics, transportation and shipping conditions. Also, the present invention will engage the space of “geographic consumption”, whereby traditional media outlets and consumer-oriented companies such as Nielsen or Apple could receive data from users on where/when and under what environmental conditions the user is experiencing a particular company's product or service. The objective would be to gain currently-unavailable individual-level insight into a company's customers, on a mass scale.

The present invention will enable a time/location/environmental dimension to users of social media, such that, subject to privacy considerations, people in their network could receive predictive modeling datapoints on what/where the individual will do next (i.e., broadening today's more geo/time-limited social media applications that inform where someone is or has been—but not yet inform others of forward-looking/predictive data).

Although this invention has been described with a certain degree of particularity, it is to be understood that the present disclosure has been made only by way of illustration and that numerous changes in the details of construction and arrangement of parts may be resorted to without departing from the spirit and the scope of the invention.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A system for predicting an event; comprising:
a memory that stores computer-readable instructions;
a processor, communicatively coupled to the memory that facilitates execution of the computer executable instructions; and
a plurality of users,
wherein the plurality of users have a user account comprising:
an identifier,
personal information provided by said plurality of users,
a log of the locations of the plurality of users when using the system,
a server configured to:
receive information of a plurality of events from the plurality of users;
comprising at least one of the following:
a photograph;
a sound recording;
a location stamp;
a custom text or descriptor;
a time stamp;
a source identifier; and/or
a customizable classification;
store said information of the plurality of events to a plurality of databases;
record the information of the plurality of events; and
predict an event of similar nature from the information of the plurality of events.

2. The system of claim 1, wherein said event information is published on a map that is available to all users of the system.

3. The system of claim 1, further comprising a second database,
wherein said second database contains a plurality of profiles,
each one of said profiles being associated with an individual user.

4. The system of claim 3, wherein each of said plurality of profiles is annotated whenever the user each profile is associated with sends event information.

5. The system of claim 1, wherein, when a first user is in the vicinity of a reported event, a notification is sent to said user.

6. The system of claim 1, wherein a first user's account has the ability to be linked to a second user's account.

7. The system of claim 6, wherein the first user is notified of repeat events recorded by the second user.

8. The system of claim 7, wherein the notifications increase in severity with each repeated event.

9. A computer implemented method for predicting an event; comprising:
registering, via a processor, a user account for a plurality of users, comprising:
an identifier,
personal information provided by said plurality of users,
a log of locations of the plurality of users when using the system,
receiving, via a processor, information from a plurality of events from the plurality of users, comprising at least one of the following:
a photograph;
a sound recording;
a location stamp;
a custom text or descriptor;
a time stamp;
a source identifier; and/or
an environmentally-specific classification;
storing, via a processor, said information of the plurality of events to a plurality of databases;
recording, via a processor, the information of the plurality of events; and
predicting, via a processor, an event of a similar nature from the information of the plurality of events.

10. A computer implemented method, comprising:
collecting a plurality of pieces of information;
organizing the plurality of pieces of information;
culling a desired portion of the plurality of pieces of information;
analyzing similarities and differences between the plurality of pieces of information;
drawing conclusions based on the said analysis;
communicating conclusions to appropriate and selected recipients.

11. The computer implemented method of claim 11, wherein the plurality of pieces of information comprises:
a location stamp;
a time stamp;
and/or other desired information.
